(19) United States
(12) Patent Application Publication
(10) Pub. No.: US 2015/0011725 A1
(43) Pub. Date: Jan. 8, 2015

(54) NYLON POLYMER AND PROCESS

(71) Applicant: INVISTA North America S.a r.l., Wilmington, DE (US)

(72) Inventors: Gurusamy Rajendran, League City, TX (US); Cheng Zhang, Rockville, MD (US); Anne Gaffney, West Chester, PA (US)

(21) Appl. No.: 14/375,036

(22) PCT Filed: Oct. 9, 2012
(86) PCT No.: PCT/IB2012/002848

§ 371 Date: Jul. 28, 2014

Related U.S. Application Data
(60) Provisional application No. 61/610,226, filed on Mar. 13, 2012.

(51) Int. Cl. C08G 69/08; C08G 69/06

(52) U.S. Cl. CPC C08G 69/08; C08G 69/06
USPC 528/310

(57) ABSTRACT

Provided is a process for producing a nylon polymer comprising the steps of contacting an omega-terminal fatty acid or fatty acid ester with a pentenenitrile to produce a nitrile-functionalized unsaturated fatty acid or fatty acid ester, hydrogenating the nitrile-functionalized unsaturated fatty acid or fatty acid ester with hydrogen in the presence of a hydrogenation catalyst to produce a saturated amino acid and subjecting the saturated amino acid to polyamidation conditions to provide a nylon polymer.

### FIELD OF THE INVENTION

The disclosures herein relate to methods of chemical transformation and to a process especially directed toward making polyamide polymers, in particular nylon 12. These disclosures enable a process for the synthesis of saturated amino acids, starting from omega-terminal fatty acids or fatty acid esters and pentenenitriles, and employ the methods of metathesis chemistry.

### BACKGROUND OF THE INVENTION

Polyamides are a family of synthetic polymers characterized by repeating units linked by amide groups. Where the repeating units between amide linkages are substantially aliphatic, the polyamide polymers are called nylon. Polymers of this type are made through the condensation reaction between a diamine and a diacid. Other polymers can be made via the self-condensation of a carboxylic acid having an omega terminal amine group (an omega-amino acid) or a ring-opening polymerization of a lactam form of the amino acid.

Nylon is one of the earliest polymers to be commercialized and one of the most widely used polymers. Commonly available nylon polymers have the names: nylon 66, nylon 6, nylon 11, nylon 12, nylon 46, nylon 612, and nylon 610; to name a few. The numbers in the naming nomenclature stand for the number of carbon atoms in the monomers used to produce the nylon. Where there are at least two numbers greater than one in the name, the nylon is made from a diamine and a diacid, the first one being the number of carbon atoms in the diamine and the second one being the number of carbon atoms in the diacid. For example, nylon 66 is made from the condensation reaction between hexamethylenediamine, a linear aliphatic diamine having 6 carbons, and adipic acid, a linear aliphatic diacid having 6 carbons. When the nylon is made from ring-opening reaction of a lactam, the number is the carbon atoms in the lactam. For example, nylon 6 is made from ring-opening reaction of caprolactam and nylon 12 is made from ring-opening reaction of laurolactam, a 12 carbon atom lactam form of an omega-terminal amino acid, a.k.a. ω-amino acid. Odd nylons like nylon 7 exist, but the 7 carbon atom lactam form is atypical. The self-condensation of a 7 carbon atom omega-terminal amino acid monomer is typical.

Nylon 66, polyhexamethylene adipamide, is the first commercially successful nylon finding wide-spread use as an artificial textile filament. It known from U.S. Pat. No. 2,130,948; issued Sep. 20, 1938 to Carothers and included a claim to “An artificial filament comprising polymeric hexamethylene adipamide.”

Traditional petroleum based intermediates are widely used to make nylon. For example, cyclohexane, is used to make adipic acid and caprolactam. Butadiene and natural gas are important raw materials for making hexamethylene diamine. Nylon 12 is also dependent upon butadiene feedstocks. There are good reasons to believe that costs for these starting materials, linked to the price of petroleum, will increase in the future. As a result it is desirable to find more sustainable raw materials, other than purely petroleum based, as starting materials for nylon intermediates.

### SUMMARY OF THE INVENTION

The present invention relates to a process for making nylon polymers from sustainable raw materials. The process involves the synthesis of saturated amino acids starting from omega-terminal fatty acids or fatty acid esters and pentenenitriles, and employs the method of metathesis chemistry.

In one embodiment of the present invention, the process comprises the steps of:
a) contacting an omega-terminal fatty acid or fatty acid ester with a pentenenitrile to produce a nitrile-functionalized unsaturated fatty acid or fatty acid ester, wherein the omega-terminal fatty acid or fatty acid ester has a carbon fatty acid chain length between 8 and 25, and wherein the reaction takes place in the presence of a metathesis catalyst;
b) hydrogenating the nitrile-functionalized unsaturated fatty acid or fatty acid ester from step (a) with hydrogen in the presence of a hydrogenation catalyst to produce a saturated amino acid; and
c) subjecting the saturated amino acid from step (b) to polyamidation conditions to provide a nylon polymer.

In another embodiment, the omega-terminal fatty acid or fatty acid ester is 9-decenoic acid, the pentenenitrile is 2-pentenenitrile, the nitrile-functionalized unsaturated fatty acid or fatty acid ester is a C11 nitrile acid of the formula NCHC═CH(CH2)7COOH, the saturated amino acid is a C11 amino acid of the formula NH2CH2(CH2)9COOH and the nylon polymer is nylon 11.

In another embodiment, the omega-terminal fatty acid or fatty acid ester is 9-decenoic acid, the pentenenitrile is 3-pentenenitrile, the nitrile-functionalized unsaturated fatty acid or fatty acid ester is a C12 nitrile acid of the formula NCCH2HC═CH(CH2)7COOH, the saturated amino acid is a C12 amino acid of the formula NH2CH2(CH2)10COOH and the nylon polymer is nylon 12.

In another embodiment, the omega-terminal fatty acid or fatty acid ester is 10-undecenoic acid, the pentenenitrile is 2-pentenenitrile, the nitrile-functionalized unsaturated fatty acid or fatty acid ester is a C12 nitrile acid of the formula NCCH2HC═CH(CH2)7COOH, the saturated amino acid is a C12 amino acid of the formula NH2CH2(CH2)10COOH and the nylon polymer is nylon 12.

In another embodiment, the omega-terminal fatty acid or fatty acid ester is 10-undecenoic acid, the pentenenitrile is 3-pentenenitrile, the nitrile-functionalized unsaturated fatty acid or fatty acid ester is a C13 nitrile acid of the formula NCCH2HC═CH(CH2)8COOH, the saturated amino acid is a C13 amino acid of the formula NH2CH2(CH2)11COOH and the nylon polymer is nylon 13.

Another embodiment of the present invention comprises the steps of:
a) contacting an omega-terminal fatty acid or fatty acid ester with hydrogen cyanide to produce a nitrile-functionalized unsaturated fatty acid or fatty acid ester, wherein the omega-terminal fatty acid or fatty acid ester has a carbon fatty acid chain length between 8 and 25, and wherein the reaction takes place in the presence of a hydrocyanation catalyst;
b) hydrogenating the nitrile-functionalized unsaturated fatty acid or fatty acid ester from step (a) with hydrogen in the presence of a hydrogenation catalyst to produce a saturated amino acid;
c) subjecting the saturated amino acid from step (b) to polyamidation conditions to provide a nylon polymer.

In another embodiment, the omega-terminal fatty acid or fatty acid ester is dodecenoic acid, the nitrile-functionalized unsaturated fatty acid or fatty acid ester is a C12 nitrile acid of the formula NCCH2HC═CH(CH2)7COOH, the saturated amino acid is a C12 amino acid of the formula NH2CH2(CH2)10COOH and the nylon polymer is nylon 12.

Another embodiment of the present invention comprises the steps of:
a) contacting an omega-terminal fatty acid or fatty acid ester with an unsaturated amine to produce saturated amino acid, wherein the omega-terminal fatty acid or fatty acid ester has a carbon fatty acid chain length between 8 and 25, and wherein the reaction takes place in the presence of a metathesis catalyst;
b) subjecting the saturated amino acid from step (a) to polyamidation conditions to provide a nylon polymer.

In another embodiment, the omega-terminal fatty acid or fatty acid ester is 9-decenoic acid, the unsaturated amine is allyl amine, the saturated amino acid is a C11 amino acid of the formula NH2CH2(CH2)9COOH and the nylon polymer is nylon 11.

In another embodiment, the omega-terminal fatty acid or fatty acid ester is 9-decenoic acid, the unsaturated amine is allyl amine, the saturated amino acid is a C12 amino acid of the formula NH2CH2(CH2)10COOH and the nylon polymer is nylon 12.

### DETAILED DESCRIPTION OF THE EMBODIMENTS

The embodiments herein relate to a metathesis chemical process where one or more reactant olefins undergo double bond scission and the subsequent reforming of one or more product olefins different from the reactant olefins. In such a case where the reactant olefins are of different compositions, the process is known as “cross-metathesis”. A metathetical chemical process leading to ring molecule formation or opening of a ring molecule is called “ring closing metathesis” or “ring opening metathesis”, respectively.

Metathesis is finding utility in converting olefin feed stocks of low commercial value into unsaturated chemicals of higher value. It is known that cross-metathesis of unsaturated fatty acids or unsaturated fatty acid esters with short chain olefins can produce ω-unsaturated fatty acids or fatty acid esters of higher value with chain length intermediate between the chain lengths of the reactants. As an example, oleic acid or methyl ester of oleic acid may be metathesized with ethylene in a presence of a suitable metathesis catalyst and forming 9-decenoic acid or methyl-9-decenoate, respectively. Through further chemical modifications, these terminally unsaturated acids or esters may be converted into nylon monomers.

All patents, patent applications, test procedures, priority documents, articles, publications, manuals, and other documents cited herein are fully incorporated by reference to the extent such disclosure is not inconsistent with this invention and for all jurisdictions in which such incorporation is permitted.

According to teachings found in United States Patent Application Number 2010 0168453 A1 to a METHOD FOR THE SYNTHESIS OF OMEGA-AMINO-ALKANOIC ACIDS (to Dubois, Jean-Luc); the disclosures of which are incorporated by reference in their entirety, certain metathesis catalysts are known. For example, the metathesis catalysts having a tungsten or molybdenum complex base are known from Schrock et al. (J. Am. Chem. Soc. 108 (1986) 2771 or Basset et al. in Angew. Chem., Engl. Ed., 31 (1992) 628. Another metathesis catalyst called “Grubbs' catalysts” are known from (Grubbs et al., Angew. Chem., Engl. Ed., 34 (1995) 2039 and Organic Lett. 1 (1999), which are based on ruthenium-benzylidene complexes. Certain commercially available catalysts from Materia, Inc., 60 N. San Gabriel Blvd., Pasadena, Calif., USA 91107 are widely employed in metathesis chemistry. Other sources for metathesis catalysts include: Evonik Industries AG, Rellinghauser Strafe 1-11, 45128 Essen, GERMANY and may include those catalysts found in the disclosures of U.S. Pat. No. 7,652,145.

As contemplated by the applicant's disclosures herein, a process is provided for preparing polyamides and their intermediate monomers using ω-unsaturated fatty acids or fatty acid esters, in an embodiment. Such ω-unsaturated fatty acids or fatty acid esters may be produced by subjecting longer chain unsaturated fatty acids or fat acid esters to a metathesis process provided with a suitable catalyst.

More specifically, the applicant's contemplate an embodiment where an w-unsaturated fatty acid or fatty acid ester having a C₈ to C₂₅ fatty acid chain length, such as 9-dodecenoic acid, may be cross-metathesized with an unsaturated nitrile. Suitable nitriles may be selected from, in an embodiment, 2-pentenenitrile and 3-pentenenitrile. Contacting an unsaturated nitrile and an ω-unsaturated fatty acid or fatty acid ester, in the presence of a suitable metathesis catalyst provides a nitrile-functionalized unsaturated fatty acid or fatty acid ester. In an embodiment, the resulting nitrile-functionalized unsaturated fatty acids or fatty acid esters can undergo a reduction reaction with hydrogen. Such a reduction reaction can transform the carbon-carbon double bond to a saturated carbon-carbon bond and the nitrile group to an amine group. Further intramolecular reaction may take place, in a manner known to the skilled person, where the amine and the acid or ester functionality provide a cyclic lactam. The resulting amino acid, amino ester or cyclic lactam can each, in principle, be polymerized to nylon polymer by means of polyamidation techniques known to the skilled person.

According to another embodiment of the disclosures herein, ω-unsaturated fatty acid or fatty acid ester having a C₈ to C₂₅ fatty acid chain length, such as 9-decenoic acid, may be contacted with hydrogen cyanide. Such contact in the presence of a suitable hydrocyanation catalyst provides a nitrile-functionalized fatty acids or fatty acid esters. In an embodiment, the resulting nitrile-functionalized unsaturated fatty acids or fatty acid esters can undergo a reduction reaction with hydrogen. Such a reduction reaction can transform the nitrile group to an amine group. Further intramolecular reaction may take place, in a manner known to the skilled person, where the amine and the acid or ester functionality provide a cyclic lactam. The resulting amino acid, amino ester or cyclic lactam can each, in principle, be polymerized to nylon polymer by means of polyamidation techniques known to the skilled person.

In another embodiment of the disclosures herein, an ω-unsaturated fatty acid or fatty acid ester having a C₈ to C₂₅ fatty acid chain length, such dodecenoic acid, may be contacted with an unsaturated amine. In an embodiment, the unsaturated amine is allyl amine. Contact in the presence of a suitable metathesis catalyst can provide an unsaturated amino acid or amino ester. In an embodiment, the resulting nitrile-functionalized unsaturated fatty acids or fatty acid esters can undergo a reduction reaction with hydrogen. Such a reduction reaction can transform the carbon-carbon double bond to a saturated carbon-carbon bond and the nitrile group to an amine group. Further intramolecular reaction may take place, in a manner known to the skilled person, where the amine and the acid or ester functionality provide a cyclic lactam. The resulting amino acid, amino ester or cyclic lactam can each, in principle, be polymerized to nylon polymer by means of polyamidation techniques known to the skilled person.

In another embodiment of the disclosures herein, an w-unsaturated fatty acid or fatty acid ester having a C₈ to C₂₅ fatty acid chain length, such 9-decenoic acid, is contacted with unsaturated acid or ester. In an embodiment, the unsaturated acid or ester is maleic acid. In such an example, contacting maleic acid with 9-decenoic acid in the presence of a suitable metathesis catalyst, provides an unsaturated diacid. More generally, a resulting unsaturated diacids or diesters may be reduced with hydrogen and whereby the carbon-carbon double bond becomes saturated. A resulting diacid or diester so provided can, in principle, be used to make nylon intermediates via means known to the people skilled person.

The applicants contemplate, in an embodiment, a process to provide a nylon intermediate and subsequently a nylon polymer according to a process comprising, the following steps:
in a first step, a reaction of 9-decenoic acid,
of formula, CH₂═CH—(CH₂)₇—COOH,
with 3,-pentenenitrile,
of formula, CN—CH₂—CH═CH₂CH₃,
in the presence of a suitable metathesis catalyst, and then, in a second step, subjecting the product resulting from the first step,
of formula CN—CH₂—CH═CH₂—(CH₂)₇—COOH,
to a reduction reaction in the presence of hydrogen and a suitable hydrogenation catalyst, to produce 12-aminododecanoic acid,
of formula H₃N—(CH₂)₁₁—COOH,
and finally, in a third step, subjecting the product resulting from the second step to polyamidation conditions to provide nylon 12.

Preparation of the nylon polymers useful within scope of these disclosures is effected by polymerization processes generally known to the skilled person. For example, the applicant's contemplate either a batch autoclave or discontinuous method and the continuous or CP method.

According to the conventional batch autoclave method, a 40-60% amino acid salt solution, is charged into a pre-evaporator vessel operated at a temperature of about 130-160° C. and a pressure of about 240 to about 690 kPa absolute, wherein the polyamide salt solution is concentrated to about 70-80%. This concentrated solution is transferred to the autoclave, where heating is continued as the pressure in the vessel rises to about 1100 to about 4000 kPa absolute. Steam is vented until the batch temperature reaches about 220-260° C. The pressure is then reduced slowly (over about 60-90 minutes) to about less than 100 kPa absolute. The polymer molecular weight is controlled by the hold time and pressure at this stage. Salt concentration, pressure, and temperature may vary depending on the specific polyamide being processed. After the desired hold time, the polyamide is then extruded into strand, cooled, and cut into pellets (also known as granulates).

Continuous polymerizations (CP) are known to the skilled person from at least the disclosures of W. H. Li in U.S. Pat. No. 3,113,843. In the continuous method, an amino acid (or polyamide) salt solution is preheated in a vessel to about 40-90° C. and transferred into a pre-evaporator/reactor where the salt solution is concentrated at about 1350 to about 2000 kPa absolute and about 200-260 C to about 70-90%, resulting in a low molecular weight polymer. The low molecular weight polymer is then discharged into a flasher, where the pressure is slowly reduced to below 100 kPa absolute and discharged into a vessel maintained below atmospheric pressure and at a temperature of about 270-300° C. to effect removal of water and to promote further molecular weight increase. The polyamide melt is then extruded into a strand, cooled, and cut into pellets.

Accordingly, the foregoing aspects are set forth without any loss of generality to, and without imposing limitations upon any claimed invention. It is to be understood that this disclosure is not limited to particular aspects described, as such may vary. It is also to be understood that the terminology used herein is for the purpose of describing particular aspects only, and is not intended to be limiting, since the scope of the present disclosure will be limited only by the appended claims.

Unless indicated otherwise: parts are parts by weight, concentration in % is % by weight (sometimes abbreviated as “wt %”), temperature is in ° C., and pressure is in atmospheres. Pressures reported in pounds per square inch gauge (psig) include the pressure of one atmosphere (14.7 pounds per square inch). One atmosphere is equivalent to 14.7 pounds per square inch absolute or 0 pounds per square inch gauge. Standard temperature and pressure are defined as 25° C. and 1 atmosphere.

As used herein, for both the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and non-limiting.

### EXAMPLES

### Example 1

In an example, a weighed amount of 9-decenoic acid, and a weighed amount 3-pentenenitrile are placed in contact with a measured amount of a second-generation Grubbs catalyst conveniently dissolved in toluene and added over a measured period of time under nitrogen and with magnetic stirring. At the end of the addition, the mixture is allowed to react undisturbed. The reaction mixture is analyzed by gas chromatography, according to methods known to the skilled person. The conversion of the 9-decenoic acid, CH₂═CH—(CH₂)₇—COOH is at least 50%. The selectivity toward CN—CH₂—CH═CH₂—(CH₂)₇—COON is 60%.

Reduction of the product of the previous step, CN—CH₂—CH=CH═CH₂—(CH₂)₇—COOH, with hydrogen is carried out to provide 12-aminododecanoic acid, H₃N—(CH₂)₁₁—COOH, according to known methods. A stirred autoclave is loaded with a measured amount of CN—CH₂—CH═CH₂—(CH₂)₇—COON and an effective quantity of Raney® 2724 cobalt catalyst, which is washed with water until the wash water is neutral and dried. The autoclave is purged with nitrogen, sealed, and ammonia is added to the autoclave in the known manner. The stirrer is started and run at 1000 rpm, and hydrogen is added to the autoclave to give an initial internal pressure of about 650 psig at room temperature. The autoclave is heated to 190° C. and hydrogen is added until the internal pressure of the autoclave is about 2500 psig. The mixture is stirred and heated for a measured time period, the autoclave is then cooled to room temperature, vented to atmospheric pressure. The product is filtered to remove catalyst. The amino acid product contains >90% primary amine end groups.

The product of the previous step, 12-aminododecanoic acid, H₃N—(CH₂)₁₁—COOH, is subjected then to a conventional batch autoclave method to form a polyamide. In the known manner, a 40-60% amino acid salt solution, is charged into a pre-evaporator vessel operated at a temperature of about 130-160° C. and a pressure of about 240 to about 690 kPa absolute, the polyamide salt solution is concentrated to about 70-80%. The concentrated solution is transferred to the autoclave, where heating is continued as the pressure in the vessel rises to about 1100 to about 4000 kPa absolute. Steam is vented until the batch temperature reaches about 220-260° C. The pressure is then reduced slowly (over about 60-90 minutes) to about less than 100 kPa absolute. The polymer molecular weight can be controlled by the hold time and pressure at this stage. After the desired hold time, the polyamide is then extruded into strand, cooled, and cut into granulates of nylon 12.

The foregoing disclosure constitutes a description of specific embodiments contemplated by the applicants and illustrate how the invention may be used and applied. Such embodiments are exemplary. The invention in its broadest aspects is further defined in the claims which follow. These claims and terms used therein are to be taken as variants of the invention described. These claims are not restricted to such variants but are to be read as covering the full scope of the invention implicit within the disclosures herein.

Methyl 10-undenoate (96.0%), 2-pentenenitrile (99.9%), 3-pentenenitrile (96.0%) and toluene used in Example 2 to 5 were distilled and passed through a plug of activated aluminum oxide before use. Other reagents were used as received.

### Example 2

### Synthesis of 11-cyano-10-undecenoic acid methyl ester using toluene as the reaction solvent

Metathesis reactions are carried out in a glass reactor equipped with heating mantle, magnetic stirrer, cooling condenser, nitrogen tube, thermocouple and sampling tube. The reactor is charged with methyl 10-undecenoate (2.066 g), 2-pentenenitrile (4.060 g), 2nd generation Grubbs catalyst and toluene (14.739 g).

Dodecane (0.600 g) is added as an internal standard for GC analysis. The reaction mixture is degassed with nitrogen for 5 minute. Following degassing the mixture is allowed to react at 40° C. for 4 hours. A nitrogen blanket is used throughout the reaction. Samples are taken periodically during the reaction for GC analysis. Butyl vinyl ether is added to the samples to quench the reaction. Conversion of methyl 10-undecenoate and yield of 11-cyano-10-undecenoic acid methyl ester are calculated using GC data at the reaction time of 3 hours. After 3 hours conversion and yield did not change significantly.

| | | | % Yield of 11- |
|---|---|---|---|
| | | | cyano-10- |
| | | % Conversion | undecenoic |
| | Catalyst | of methyl 10- | acid methyl |
| Example No. | Loading¹ | undecenoate | ester |
| 2-1 | 0.1 | 6.9 | 5.8 |
| 2-2 | 0.5 | 82.0 | 75.3 |

¹Catalyst loading is given as mole of catalyst per 100 mole of methyl 10-undecenoate.

### Example 3

### Synthesis of 11-cyano-10-undecenoic acid methyl ester without using a reaction solvent

Metathesis reactions are carried out in a glass reactor equipped with heating mantle, magnetic stirrer, cooling condenser, nitrogen tube, thermocouple and sampling tube. The reactor is charged with methyl 10-undecenoate (1.033 g), 2-pentenenitrile (2.030 g) and 2nd generation Grubbs catalyst. Dodecane (0.300 g) is added as an internal standard for GC analysis. The reaction mixture is degassed with nitrogen for 5 minutes. Following degassing the mixture is allowed to react at 40° C. for 4 hours. A nitrogen blanket is used throughout the reaction. Samples are taken periodically during the reaction for GC analysis. Butyl vinyl ether is added to the samples to quench the reaction. Conversion of methyl 10-undecenoate and yield of 11-cyano-10-undecenoic acid methyl ester are calculated using GC data at the reaction time of 3 hours. After 3 hours conversion and yield do not change significantly.

| | | | % Yield of 11- |
|---|---|---|---|
| | | | cyano-10- |
| | | % Conversion | undecenoic |
| | Catalyst | of methyl 10- | acid methyl |
| Example No. | Loading¹ | undecenoate | ester |
| 3-1 | 0.1 | 10.1 | 8.5 |
| 3-2 | 0.5 | 38.4 | 34.5 |
| 3-3 | 2 | 66.3 | 59.9 |

¹Catalyst loading is given as mole of catalyst per 100 mole of methyl 10-undecenoate.

### Example 4

### Synthesis of 12-cyano-10-dodecenoic acid methyl ester using toluene as the reaction solvent

Metathesis reactions are carried out in a glass reactor equipped with heating mantle, magnetic stirrer, cooling condenser, nitrogen tube, thermocouple and sampling tube. The reactor is charged with methyl 10-undecenoate (2.066 g), 3-pentenenitrile (4.225 g), 2nd generation Grubbs catalyst (0.0085 g) and toluene (14.739 g). Dodecane (0.600 g) is added as an internal standard for GC analysis. The reaction mixture is degassed with nitrogen for 5 minutes. Following degassing the mixture is allowed to react at 40° C. for 4 hours. A nitrogen blanket is used throughout the reaction. Samples are taken periodically during the reaction for GC analysis. Butyl vinyl ether is added to the samples to quench the reaction. Conversion of methyl 10-undecenoate at the reaction time of 3 hours is 13.1% and yield of 12-cyano-10-dodecenoic acid methyl ester is 12.2%. After 3 hours conversion and yield do not change significantly.

### Example 5

### Synthesis of 12-cyano-10-dodecenoic acid methyl ester without using a reaction solvent

Metathesis reactions are carried out in a glass reactor equipped with heating mantle, magnetic stirrer, cooling condenser, nitrogen tube, thermocouple and sampling tube. The reactor is charged with methyl 10-undecenoate, 3-pentenenitrile and 2nd generation Grubbs catalyst. Dodecane is added as an internal standard for GC analysis. The reaction mixture is degassed with nitrogen for 5 minutes. Following degassing the mixture is allowed to react at 40° C. for 4 hours. A nitrogen blanket is used throughout the reaction. Samples are taken periodically during the reaction for GC analysis. Butyl vinyl ether is added to the samples to quench the reaction. Conversion of methyl 10-undecenoate and yield of 11-cyano-10-undecenoic acid methyl ester are calculated using GC data at the reaction time of 3 hours. After 3 hours conversion and yield do not change significantly.

| | | | | | % Yield of |
|---|---|---|---|---|---|
| | | | | | 12-cyano- |
| | | | 2^{nd} | % | 10- |
| | Methyl 10- | 3- | generation | Conversion | dodecenoic |
| Example | undecenoate | Pentenenitrile | Grubbs | of methyl 10- | acid methyl |
| No. | (g) | (g) | catalyst (g) | undecenoate | ester |
| 5-1 | 1.033 | 2.113 | 0.021 | 91.7 | 84.2 |
| 5-2 | 1.653 | 1.352 | 0.034 | 86.7 | 78.5 |

### Example 6

### Synthesis of 13-amino tridecanoic acid methyl ester using methanol as the reaction solvent

Hydrogenation of 12-cyano-10-dodecenoic acid methyl ester is conducted in a stainless tube reactor equipped with a heating tape and a hydrogen inlet. The stainless tube reactor has an out-diameter of 0.5″, a wall thickness of 0.035″ and length of 2′. 12-Cyano-10-dodecenoic acid methyl ester is prepared as described in Example 4-2 and purified by passing through a silica gel column. The stainless steel tube reactor is charged with purified 12-cyano-10-dodecenoic acid methyl ester (3.0 g), Raney® cobalt 2724 catalyst (0.15 g), and methanol (15 g). Reaction is carried out at 150° C. for 18 hours. Hydrogen pressure in the reactor is controlled at 800 psig throughout the reaction. Mixing of the reaction content is achieved by shaking the tube reactor with a reciprocally shaking bed. GC analysis shows quantitative conversion of 12-cyano-10-dodecenoic acid methyl ester after 18 hours. The yield of 13-amino tridecanoic acid methyl ester is 54.2%.

### Example 7

### Synthesis of 13-amino tridecanoic acid methyl ester using tetrahydrofuran as the reaction solvent

Hydrogenation of 12-cyano-10-dodecenoic acid methyl ester is conducted in a stainless tube reactor equipped with a heating tape and a hydrogen inlet. The stainless tube reactor has an out-diameter of 0.75″, a wall thickness of 0.035″ and length of 2′. 12-Cyano-10-dodecenoic acid methyl ester is prepared as described in Example 4-2 and purified by passing through a silica gel column. The stainless steel tube reactor was charged with purified 12-cyano-10-dodecenoic acid methyl ester (3.0 g), Raney® cobalt 2724 catalyst (0.15 g), and tetrahydrofuran (15 g). Reaction is carried out at 180° C. for 18 hours. Hydrogen pressure in the reactor is controlled at 800 psig throughout the reaction. Mixing of the reaction content is achieved by shaking the tube reactor with a reciprocally shaking bed. GC analysis shows quantitative conversion of 12-cyano-10-dodecenoic acid methyl ester after 18 hours. The yield of 13-amino tridecanoic acid methyl ester is 69.7%.

| | PN | | Catalyst | PN-UDE |
|---|---|---|---|---|
| Example # | isomer | Solvent | load (%) | ratio |
| 1-1 | 2-PN | Toluene | 0.1 | 5 |
| 1-2 | 2-PN | Toluene | 0.5 | 5 |
| 2-1 | 2-PN | No | 0.1 | 5 |
| 2-2 | 2-PN | No | 0.5 | 5 |
| 2-3 | 2-PN | No | 2 | 5 |
| 3 | 3-PN | Toluene | 0.1 | 5 |
| 4-1 | 3-PN | No | 0.5 | 5 |
| 4-2 | 3-PN | No | 0.5 | 2 |

### APPENDIX

### NYLON VARIETIES (11, 12, 13, 88, 1010, 108, 810)

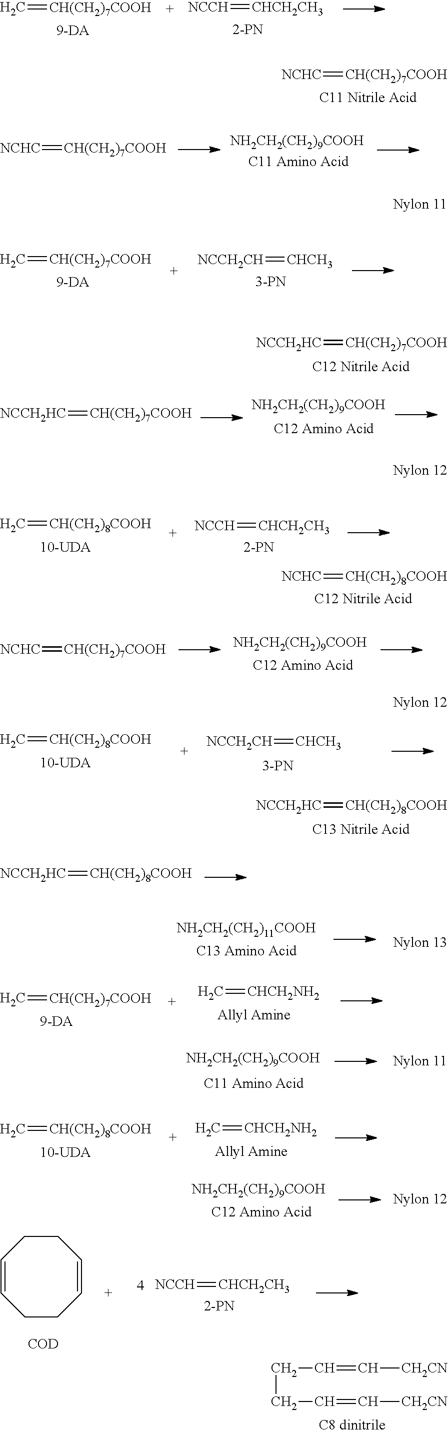

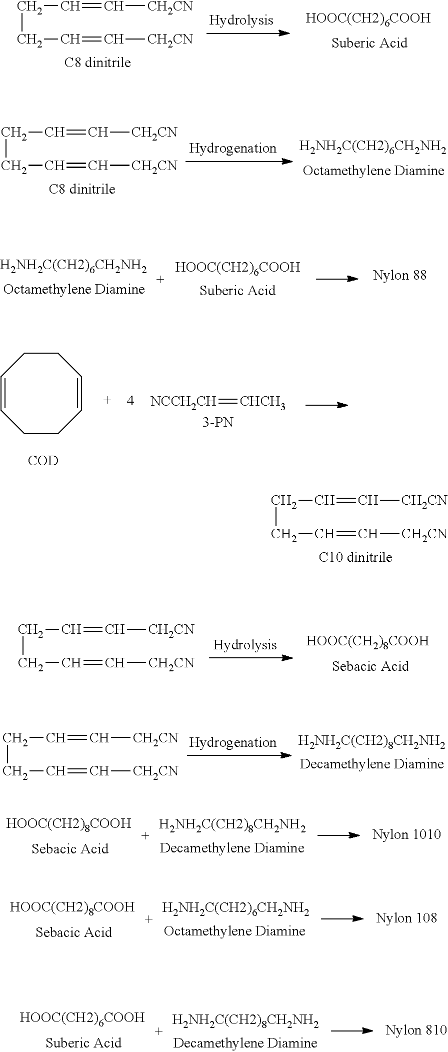

1. A process for producing a nylon polymer comprising the steps of:
a) contacting an omega-terminal fatty acid or fatty acid ester with 2-pentenenitrile or 3-pentenenitrile to produce a nitrile-functionalized unsaturated fatty acid or fatty acid ester, wherein the omega-terminal fatty acid or fatty acid ester has a carbon fatty acid chain length between 8 and 25, and wherein the reaction takes place in the presence of a metathesis catalyst;
b) hydrogenating the nitrile-functionalized unsaturated fatty acid or fatty acid ester from step (a) with hydrogen in the presence of a hydrogenation catalyst to produce a saturated amino acid; and
c) subjecting the saturated amino acid from step (b) to polyamidation conditions to provide a nylon polymer.

2. The process of claim 1 wherein the omega-terminal fatty acid or fatty acid ester is 9-decenoic acid, the pentenenitrile is 2-pentenenitrile, the nitrile-functionalized unsaturated fatty acid or fatty acid ester is a C11 nitrile acid of the formula NCHC═CH(CH₂)₇COOH, the saturated amino acid is a C11 amino acid of the formula NH₂CH₂(CH₂)₉COOH and the nylon polymer is nylon 11.

3. The process of claim 1 wherein the omega-terminal fatty acid or fatty acid ester is 9-decenoic acid, the pentenenitrile is 3-pentenenitrile, the nitrile-functionalized unsaturated fatty acid or fatty acid ester is a C12 nitrile acid of the formula NCCH₂HC═CH(CH₂)₇COOH, the saturated amino acid is a C12 amino acid of the formula NH₂CH₂(CH₂)₁₀COOH and the nylon polymer is nylon 12.

4. The process of claim 1 wherein the omega-terminal fatty acid or fatty acid ester is 10-undecenoic acid, the pentenenitrile is 2-pentenenitrile, the nitrile-functionalized unsaturated fatty acid or fatty acid ester is a C12 nitrile acid of the formula NCCH₂HC═CH(CH₂)₇COOH, the saturated amino acid is a C12 amino acid of the formula NH₂CH₂(CH₂)₁₀COOH and the nylon polymer is nylon 12.

5. The process of claim 1 wherein the omega-terminal fatty acid or fatty acid ester is 10-undecenoic acid, the pentenenitrile is 3-pentenenitrile, the nitrile-functionalized unsaturated fatty acid or fatty acid ester is a C13 nitrile acid of the formula NCCH₂HC═CH(CH₂)₈COOH, the saturated amino acid is a C13 amino acid of the formula NH₂CH₂(CH₂)₁₁COOH and the nylon polymer is nylon 13.

6. A process for producing a nylon polymer comprising the steps of:
a) contacting an omega-terminal fatty acid or fatty acid ester with hydrogen cyanide to produce a nitrile-functionalized unsaturated fatty acid or fatty acid ester, wherein the omega-terminal fatty acid or fatty acid ester has a carbon fatty acid chain length between 8 and 25, and wherein the reaction takes place in the presence of a hydrocyanation catalyst;
b) hydrogenating the nitrile-functionalized unsaturated fatty acid or fatty acid ester from step (a) with hydrogen in the presence of a hydrogenation catalyst to produce a saturated amino acid; and
c) subjecting the saturated amino acid from step (b) to polyamidation conditions to provide a nylon polymer.

7. The process of claim 6 wherein the omega-terminal fatty acid or fatty acid ester is dodecenoic acid, the nitrile-functionalized unsaturated fatty acid or fatty acid ester is a C12 nitrile acid of the formula NCCH₂HC═CH(CH₂)₇COOH, the saturated amino acid is a C12 amino acid of the formula NH₂CH₂(CH₂)₁₀COOH and the nylon polymer is nylon 12.

8. (canceled)

9. (canceled)

10. (canceled)
